(19) United States
(12) Patent Application Publication
(10) Pub. No.: US 2024/0311818 A1
(43) Pub. Date: Sep. 19, 2024

(54) SYSTEMS AND METHODS FOR RECORDING CONSUMER TRANSACTIONS

(71) Applicant: Capital One Services, LLC, McLean, VA (US)

(72) Inventors: Jeffrey RULE, Chevy Chase, MD (US); Rocky GUO, Vienna, VA (US)

(21) Appl. No.: 18/122,545

(22) Filed: Mar. 16, 2023

(51) Int. Cl. G06Q 20/38; G06Q 20/32; G06Q 20/34; G06Q 20/40

(52) U.S. Cl. CPC G06Q 20/389; G06Q 20/326; G06Q 20/3278; G06Q 20/352; G06Q 20/40; G06Q 20/3829

(57) ABSTRACT

The present embodiments relate to systems and methods for editing and populating data fields associated with one or more transactions. A user can further authenticate himself over a communication field in order to access the data fields.

### FIELD OF THE DISCLOSURE

The present disclosure relates to systems and methods for recording consumer transactions.

### BACKGROUND

Recording consumer transactions is an important aspect of financial planning. To best provide a user with records and of his or her spending habits, it is very important to categorize purchases as accurately as possible. However, current financial planning applications often categorize purchases inaccurately and offer very few opportunities for users to edit their spending reports to more accurately reflect their purchases. For example, many food purchases are often categorized under “dining and drinks” when they should be categorized under “grocery.” Other mischaracterizations of purchases can lead to a confusing and inaccurate spending report.

These and other deficiencies exist. Therefore, there is a need to provide systems and methods for securely and efficiently recording, categorizing, and permitting edits of transaction records and spending reports.

### SUMMARY OF THE DISCLOSURE

Aspects of the disclosed embodiments include a system and method for recording consumer transactions.

Embodiments of the present disclosure provide a method. The method begins with transmitting, from a user device to a server, a request for transaction data then receiving, by the user device from the server, an authentication request. Next, the method proceeds with opening, by the user device in response to receiving an authentication request, a communication field. Then, the method continues with transmitting, from the user device to a contactless card via the communication field, an authentication request and receiving, by the user device from the contactless card, an authentication credential. Next, the method proceeds with transmitting, by the user device to the server, a request for data associated with the completed transaction and receiving, from the server, one or more data associated with the completed transaction. The method continues with opening, in response to receiving the data associated with the completed transaction, an application configured to display one or more data fields associated with the completed transaction wherein some of the data fields have been populated with the data received from the server. Having opened the application, the user device transmits to the application one or more additional entries to the data fields. Next, the method proceeds with storing, by the user device to a data storage unit, the completed data fields and transmitting, by the user device to the server, the completed data fields.

Embodiments of the present disclosure provide a system for securely recording transaction details, the system comprising a contactless card, a server, and a user device. The user device further comprises a memory and a processor. The processor configured to transmit, from the user device to the server, a request for transaction data and receive, by the user device from the server, an authentication request. Next, the processor can open, in response to receiving the authentication request, a communication field and transmit, to the contactless card via the communication field, an authentication request. Next, the processor can receive, from the contactless card, an authentication credential and transmit, to the server, a request for data associated with the completed transaction. Next, the processor can receive, from the server in response to the request for data, one or more data associated with the completed transaction and open, in response to receiving the data associated with the completed transaction, an application configured to display via the user device one or more data fields associated with the completed transaction wherein some of the data fields have been populated with the data received from the server. Next, the processor can transmit, to the application, one or more additional entries to the data fields, store the completed data fields in a data storage unit, and transmit, to the server, the completed data fields.

Embodiments of the present disclosure provide a computer readable non-transitory medium comprising computer executable instructions that, when executed on a processor, configure the processor to perform procedures comprising the following steps: The processor proceeds with transmitting, from a user device to a server, a request for transaction data and receiving, by the user device from the server, an authentication request. Next, the processor proceeds with opening, in response to receiving the authentication request, a communication field and transmitting, to a contactless card via the communication field, an authentication request. Next, the processor proceeds with receiving, from the contactless card, an authentication credential and transmitting, to the server, a request for one or more data associated with the completed transaction. Next, the processor can proceed with receiving, from the server in response to the request for data, one or more data associated with the completed transaction and opening, in response to receiving the data associated with the completed transaction, an application configured to display via the user device one or more data fields associated with the completed transaction wherein some of the data fields have been populated with the data received from the server. Next, the processor proceeds with transmitting, to the application, one or more additional entries to the data fields and storing, in a data storage unit, the completed data fields. Finally, the proceed can conclude with transmitting, to the server, the completed data fields.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a diagram illustrating a system according to an exemplary embodiment.

FIG. 2 is a diagram illustrating a card according to an exemplary embodiment.

FIG. 3 is a flowchart illustrating a card according to an exemplary embodiment.

FIG. 4 is a diagram illustrating a method according to an exemplary embodiment.

FIG. 5 is a diagram illustrating a process according to an exemplary embodiment.

FIG. 6 is a flowchart illustrating a method according to an exemplary embodiment.

FIG. 7 is a flowchart illustrating a method according to an exemplary embodiment.

FIG. 8 is a flowchart illustrating a method according to an exemplary embodiment.

FIG. 9 is a flowchart illustrating a method according to an exemplary embodiment.

FIG. 10 is a diagram illustrating a process according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present disclosure provides a solution to a problem with merchant and banking technology, which is that the recordation of transactions rarely includes specific data. For example, a consumer may buy several items at a grocery store, including food, cleaning supplies, and cookware. Despite these items falling under different categories, most banking and merchant technology-including without limitation banking applications, merchant applications, and other applications meant to track user spending-will categorize the entire purchase under “grocery” or “food.” Thus, the consumer's purchase is over-generalized and inaccurately recorded. Consequently, both the consumer and bank have very little information to understand the consumer's spending habits.

As a solution to this problem, the present disclosure offers systems and methods for recording consumer transactions. A consumer may be performing a transaction. The consumer can authenticate themselves with a credential such as a unique user datum sent from the user's contactless card to user device, server, or some processor over a communication field. Once the user has been authenticated, the user can open an application and input data into one or more data fields. This data can be stored in a database, data storage unit, or memory. The data can also be transmitted to a server or some other processor.

For example, a user may buy several items at a grocery store, including food, cleaning supplies, and cookware. When the user is conducting the transaction or right after the transaction, the user can authenticate themselves and open an application. The user can input data related to the transaction, such as providing the data “cooking pan” regarding a purchase of a frying pan, or the data “cleaning supplies” regarding a purchase of dish soap. Any number of data and data fields can be provided regarding any category of transaction. Thus, the consumer has provided new and unique data via a secure system and method. New data is created which alone improves the past systems and methods of transaction recordation that lack nuanced, specific data. Furthermore, the consumer benefits by having a more secure, quick, and efficient way to add more data regarding a transaction. Banks and merchants benefit by receiving new data from customers that allow them to better understand a consumer's spending.

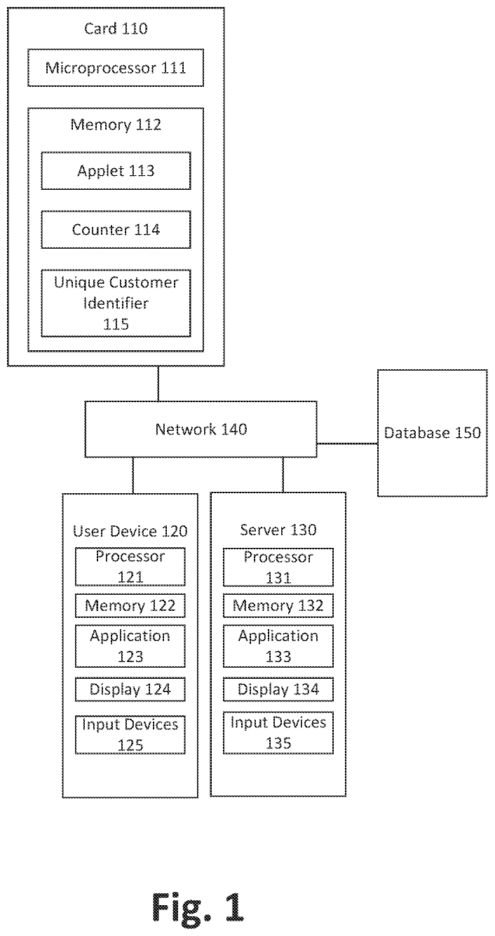

FIG. 1 illustrates a system 100 according to an example embodiment. The system 100 may comprise a contactless card 110, a user device 120, a server 130, a network 140, and a database 150. Although FIG. 1 illustrates single instances of components of system 100, system 100 may include any number of components.

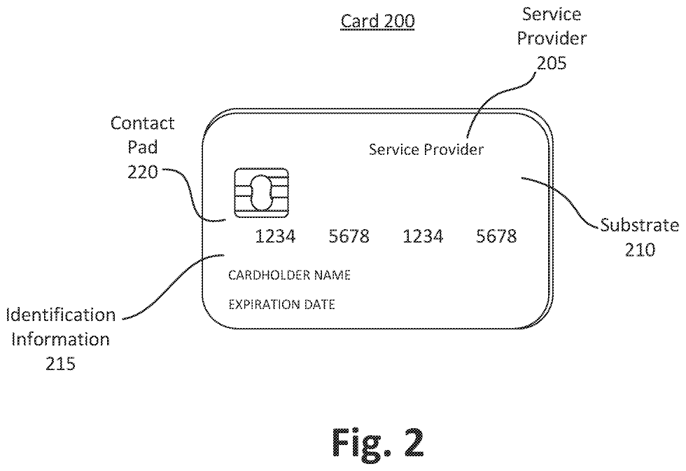

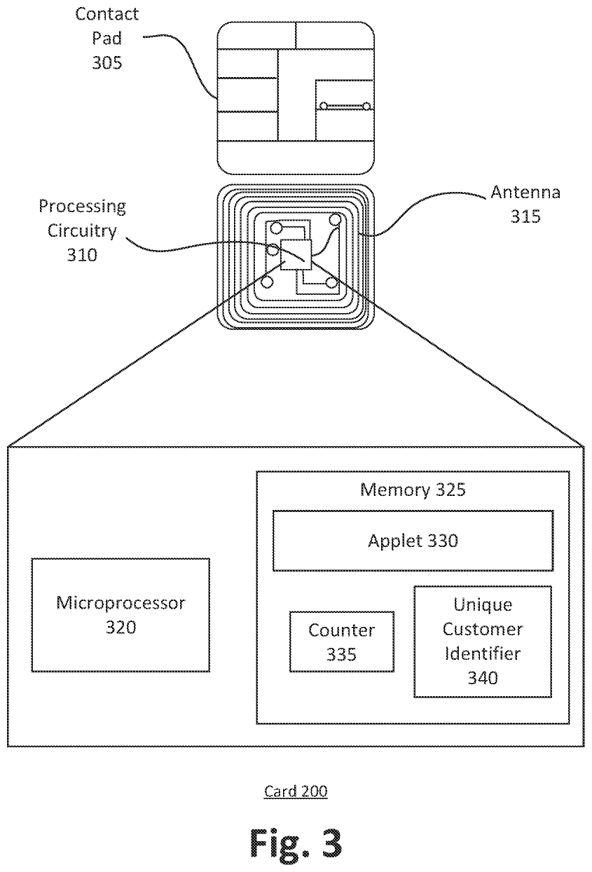

System 100 may include one or more contactless cards 110 which are further explained below with reference to FIG. 2 and FIG. 3. In some embodiments, contactless card 110 may be in wireless communication, utilizing NFC in an example, with user device 120.

System 100 may include a user device 120. The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, and an application 123. The processor 121 may be a processor, a microprocessor, or other processor, and the user device 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications, such as a mobile application and a web browser, comprising instructions for execution on the user device 120. In some examples, the user device 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein.

System 100 may include a server 130. The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's private data and financial account information.

The application 133 may comprise one or more software applications comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the application 133 may be executed to perform receiving web form data from the user device 120 and the storage device 160, retaining a web session between the user device 120 and the storage device 160, and masking private data received from the user device 120 and the storage device 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that can be available and supported by the server 130, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user device 120, the server 130, the database 150 and the ATM160. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 130 or may be hosted externally of the server 130, such as by a server, by a cloud-based platform, or in any storage device that is in data communication with the server 130.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 110, the user device 120, the server 130, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

FIG. 2 illustrates a contactless card 200 according to an example embodiment. The contactless card 200 may comprise a payment card, such as a credit card, debit card, or gift card, issued by a service provider 205 displayed on the front or back of the card 200. In some examples, the payment card may comprise a dual interface contactless payment card. In some examples, the contactless card 200 is not related to a payment card, and may comprise, without limitation, an identification card, a membership card, a loyalty card, a transportation card, and a point of access card.

The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the contactless card, and a contact pad 220. The contact pad 220 may be configured to establish contact with another communication device, such as a user device, smart phone, laptop, desktop, or tablet computer. The contactless card 200 may also include processing circuitry, antenna and other components not shown in FIG. 2. These components may be located behind the contact pad 220 or elsewhere on the substrate 210. The contactless card 200 may also include a magnetic strip or tape, which may be located on the back of the contactless card (not shown in FIG. 2).

FIG. 3 illustrates a contact pad of a contactless card 200 according to an example embodiment.

As illustrated in FIG. 3, the contact pad 305 may include processing circuitry 310 for storing and processing information, including a microprocessor 320 and a memory 325. It is understood that the processing circuitry 310 may contain additional components, including processors, memories, error and parity/CRC checkers, data encoders, anticollision algorithms, controllers, command decoders, security primitives and tamperproofing hardware, as necessary to perform the functions described herein.

The memory 325 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 325 may be configured to store one or more applets 330, one or more counters 335, and a customer identifier 340. The one or more applets 330 may comprise one or more software applications configured to execute on one or more contactless cards, such as Java Card applet. However, it is understood that applets 330 are not limited to Java Card applets, and instead may be any software application operable on contactless cards or other devices having limited memory. The one or more counters 335 may comprise a numeric counter sufficient to store an integer. The customer identifier 340 may comprise a unique alphanumeric identifier assigned to a user of the contactless card 200, and the identifier may distinguish the user of the contactless card from other contactless card users. In some examples, the customer identifier 340 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 305 or entirely separate from it, or as further elements in addition to processor 320 and memory 325 elements located within the contact pad 305.

In some examples, the contactless card 200 may comprise one or more antennas 315. The one or more antennas 315 may be placed within the contactless card 200 and around the processing circuitry 310 of the contact pad 305. For example, the one or more antennas 315 may be integral with the processing circuitry 310 and the one or more antennas 315 may be used with an external booster coil. As another example, the one or more antennas 315 may be external to the contact pad 305 and the processing circuitry 310.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

As explained above, the contactless cards 200 may be built on a software platform operable on smart cards or other devices having limited memory, such as JavaCard, and one or more or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

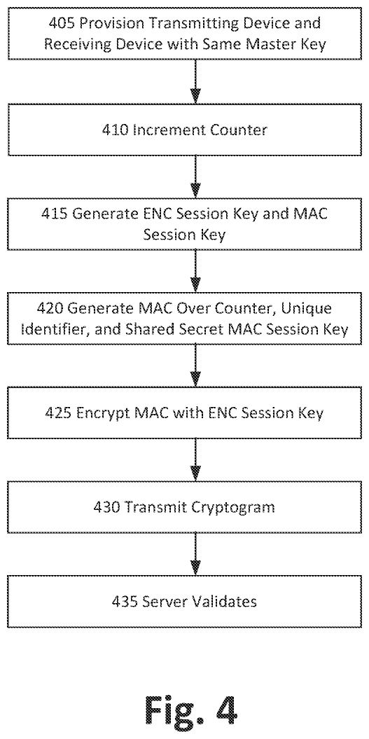

FIG. 4 is a flow chart of method 400 of key diversification according to an example of the present disclosure. The diversified key exchange provides extra security to a user-based transaction. Thus, the exchange ensures that no fraudulent parties can view or edit the user's financial statements.

For example, a sender and recipient may desire to exchange data via a transmitting device (e.g. a user device) and a receiving device (e.g. a storage device and/or a user device). As explained above, it is understood that one or more transmitting devices and one or more receiving devices may be involved so long as each party shares the same shared secret symmetric key. In some examples, the transmitting device and receiving device may be provisioned with the same master symmetric key. In other examples, the transmitting device may be provisioned with a diversified key created using the master key. In some examples, the symmetric key may comprise the shared secret symmetric key which is kept secret from all parties other than the transmitting device and the receiving device involved in exchanging the secure data. It is further understood that part of the data exchanged between the transmitting device and receiving device comprises at least a portion of data which may be referred to as the counter value. The counter value may comprise a number that changes each time data is exchanged between the transmitting device and the receiving device.

The transmitting device and the receiving device may be configured to communicate via NFC, Bluetooth, RFID, Wi-Fi, and/or the like.

The method 400 can begin with action 405. In action 405, a transmitting device and receiving device may be provisioned with the same master key, such as the same master symmetric key. The transmitting device may be the user device. The receiving device may be the contactless card. When the transmitting device is preparing to process the sensitive data with symmetric cryptographic operation, the sender may update a counter. In addition, the transmitting device may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128, a symmetric HMAC algorithm, such as HMAC-SHA-256, and a symmetric CMAC algorithm, such as AES-CMAC.

In action 410, the transmitting device may take the selected cryptographic algorithm, and using the master symmetric key, process the counter value 335. For example, the sender may select a symmetric encryption algorithm, and use a counter which updates with every conversation between the transmitting device and the receiving device The one or more counters 335 may comprise a numeric counter sufficient to store an integer. The processor may increment the counter one or more times.

In action 415, the transmitting device generates two session keys: one ENC (encryption) session key and one MAC (message authentication code) session key. The transmitting device may encrypt the counter value with the selected symmetric encryption algorithm using the master symmetric key to create a session key.

In action 420, the processor generates the MAC over the counter 335, the unique customer identifier 340, and the shared secret MAC session key. The customer identifier 340 may comprise a unique alphanumeric identifier assigned to a user of the contactless card, and the identifier may distinguish the user of the contactless card from other contactless card users. In some examples, the customer identifier 340 may identify both a customer and an account assigned to that customer and may further identify the contactless card associated with the customer's account.

In action 425, the processor encrypts the MAC with the ENC session key. As encrypted, the MAC can become a cryptogram. In some examples, a cryptographic operation other than encryption may be performed, and a plurality of cryptographic operations may be performed using the diversified symmetric keys prior to transmittal of the protected data.

In some examples, the MAC cryptogram can be a digital signature used to verify user information. Other digital signature algorithms, such as public key asymmetric algorithms, e.g., the Digital Signature Algorithm and the RSA algorithm, or zero knowledge protocols, may be used to perform this verification.

In action 430, the processor transmits a cryptogram to the receiving device. The receiving device can the contactless card 110. The cryptogram can include the applet information 330, the unique customer identifier 340, the counter value 335, and the encrypted MAC.

In action 435, the server validates the cryptogram. The server may be a part of the transmitting device or receiving device. Alternatively, the server may be a separate entity. For example, the receiving device generates its own UDKs (unique diversified keys) using the unique customer identifier 340 and the master key. The unique customer identifier is derived from the validated cryptogram. Recall that the receiving device has already been provisioned with the master key. The receiving device generates two session keys: one ENC (encryption) session key and one MAC (message authentication code) session key. The receiving device may generate these session keys from the UDKs and the counter value. The counter value can be derived from the cryptogram. The receiving device uses the session keys to decrypt the MAC from the cryptogram sent by the transmitting device. The output of the encryptions may be the same diversified symmetric key values that were created by the sender. For example, the receiving device may independently create its own copies of the first and second diversified session keys using the counter. Then, the receiving device may decrypt the protected data using the second diversified session key (e.g., the ENC session key) to reveal the output of the MAC created by the transmitting device. The receiving device may then process the resultant data through the MAC operation using the first diversified session key (e.g., the MAC session key). For example, the receiving device may validate the MAC with the MAC session key generated in step 415. In some examples, the receiving device may validate the MAC over the unique customer identifier and the counter value.

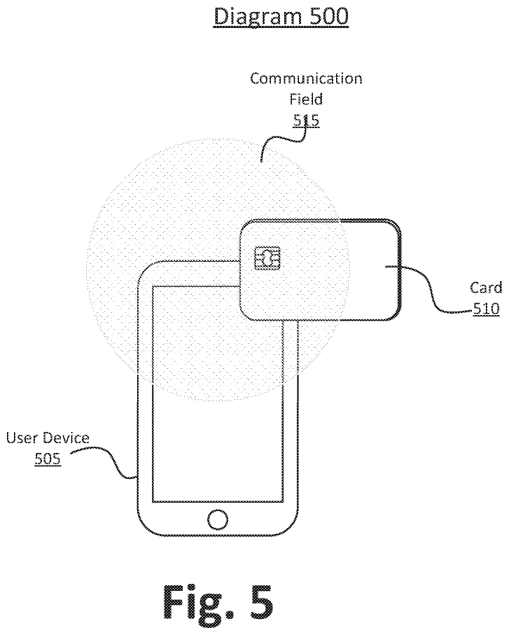

FIG. 5 is a diagram illustrating near field communication (NFC) according to an exemplary embodiment.

Generally, NFC is the transmission of data through electromagnetic radio fields which enable two or more devices to communicate with each other without touching. NFC operates at 13.56 MHz on ISO/IEC 18000-3 air interface and at rates ranging from 106 kbit/s to 424 kbit/s. When two NFC-enabled devices are placed within a very small distances (e.g. a few centimeters), they can perform a transaction of information. NFC is beneficial to consumer transactions because it allows for near instantaneous reading of information. The receiving device reads the transmitted data the instant that it is sent. Therefore, human error is greatly reduced. Additionally, NFC reduces the time need to read a card. Rather than swipe a card through a reader, a consumer can simply touch the card or user device to an NFC enabled reader. Additionally, NFC reduces the risk of interference from fraudulent parties. Because NFC devices may communicate only over a very short distance, it is extremely difficult to intercept the information being sent between the devices.

Some examples of NFC communication include NFC card emulation where smartphones act like smart cards allowing users to perform transactions such as payment. As another example, NFC reader/writer communication allows devices to read information stored on NFC tags embedded into labels or smart posters. As another example, NFC peer-to-peer communication allows two NFC-enabled devices to communicate with each other to exchange information.

NFC standards cover communications protocols and data exchange formats, and are based on existing RFID standards including ISO/IEC 14443 and FeliCa. The standards include ISO/IEC 18092 and those defined by the NFC Forum.

In FIG. 5, a user device 505 and a contactless card 510 are interacting within an NFC field 515. The user device is further explained with reference to FIG. 1. The contactless card is further explained with reference to FIGS. 2 and 3. Both the user device and contactless card may be enabled with NFC technology. The user and the contactless card are in close contact with each other so that they can exchange information within the communication field.

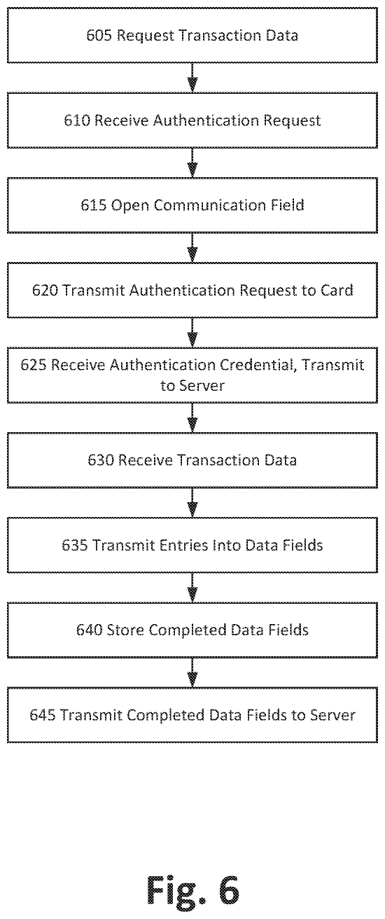

FIG. 6 is a method flowchart illustrating a method according to an exemplary embodiment. The method can include a contactless card, a user device, and a server. The method can also include a mobile application or web application. The contactless card is discussed with further reference to FIGS. 2-3.

In action 605, a user device can request transaction data from a server. The user device can transmit the request over a wireless network to a server. For example, the user can request the transaction data from their most recent purchase of sneakers. The user device can transmit the request over a wireless network to a server associated with a financial institution such as the user's banking institution or credit card provider. Additionally, the notification can include a request to view the completed transaction and supply more categorical information regarding the transaction. The server can be associated with a merchant or some other consumer entity. For example, the user may have just purchased a pair of shoes from a merchant. The user may have used a contactless card to make the purchase. The merchant can receive the transaction information and based on the information provided by the contactless card via the purchase, send a notification to the user device. In other embodiments, the user can receive a notification from a serve associated with a financial institution or third-party financial planning application. The financial institution can be a banking institution with which the user holds a spending account, savings account, or investment account. The third-party financial planning application can be a spending, budgeting, or lifestyle-planning application configured track spending, categorizing spending habits, generate a spending profile for a user, make saving and spending suggestions, and perform other financial planning functions. Upon transmitting the request, in action 610 the user device can receive an authentication request from the server.

In action 615, the user device can open a communication field. Communication fields are discussed with further reference to FIG. 5.

In action 620, the user can transmit an authentication request from a user device to a contactless card via the communication field. In response, the user device can receive an authentication credential form the contactless card in action 625 then transmit the authentication credential. The authentication credential can include a MAC via a diversified key exchange between the user device and the contactless card. A diversified key exchange is discussed with further detail in FIG. 4. The authentication exchange ensures that the user is present with both the user device and the contactless cad, ensuring that the person trying to access the transaction data is not a fraudulent party. Upon receiving the authentication credential from the contactless card, the user device transmits the credential to the server. Upon receiving the authentication credential, the server can match the authentication credential with the user profile or user transaction profile. Upon matching the credential with the user transaction profile, the server can retrieve the transaction data. The transaction data can be associated with the most recent transaction associated with the card. In other embodiments, the transaction data can be dynamically chosen by the user device or user device application. In other embodiments, the transaction data can include a batch of the most recent transaction associated with the card. The batch can be sent to the user device at which point the user can select which transaction they wish to record.

In response to the request, in action 630 the user device can receive the transaction data from the server. The transaction data can include without limitation the spend amount per transaction, the spend amount per item, time of transaction, location of transaction, type or category of transaction, frequency of transaction, or some other transaction information. The data can be presented as a number of data fields that, depending on the transaction, may or may not be filled. For example, the transaction data associated with user's purchase of a pair of shoes may be missing the location of the transaction or the category of transaction. To view the transaction data and the one or more data fields, the user device can be directed to a mobile or web application associated with the banking or financial institution. In some embodiments, the user device or a user device application can access a spending habit report, wherein the spending habit report has been generated by the user device based on current and historical data fields from current and past transactions. The spending habit report can be retrieved from a database, data storage unit, memory, or from the server.

In action 635, the user can transmit one or more entries into the data fields. As a nonlimiting example, the user may fill one of the data fields by typing in the date of the shoe purchase. As another example, the user may tap their contactless card to the phone again to fill a data field with contactless card information.

Once the fields have been filled, in action 640 the user device can store the completed data fields on the user device or some other local storage. In action 645, the user device can transmit the completed data fields to the server over a wireless network. Having received the completed data fields, the server can store the fields in a database or data storage unit. The user device can, upon authenticating itself, retrieve the information for later observation.

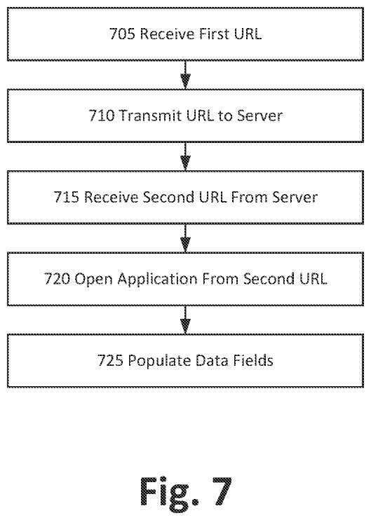

FIG. 7 is a flowchart illustrating a method according to an exemplary embodiment. The method can include a contactless card, a user device, and a server. The method can also include a mobile application or web application. The contactless card is discussed with further reference to FIGS. 2-3. In some embodiments, to direct the user device to the appropriate web application or mobile application, the contactless card can send a first URL to the server via the user device. Then, the server can transmit the second URL which directs the user to the financial application.

In action 705, the user device can receive a first uniform resource location (URL) from the contactless card. The contactless card can be provisioned with this first URL. The first URL can be transmitted from the contactless card to the user device via a communication field. The contactless card can send the URL in payload to the user device. This first URL can be fixed such that it cannot be changed. In other embodiments, the URL can be changed dynamically. In action 710, the URL is sent by the user to the server over a wireless network. The server can match the URL with a user or account on file. Once the server identifies the user, the server can retrieve a second URL associated with the user and transmit this second URL to the user device over a wireless network. In action 715, the user device can receive the second URL from the server. The second URL can direct the user device to a mobile or web application. For example, the second URL can direct the user device to a mobile application already downloaded on the device. In other embodiments, the second URL can direct the user to a web application on the internet. In other embodiments, the second URL can direct the user device to an application store where they can download the appropriate mobile application. The second URL can be associated with a website application or mobile application further configured to display the one or more data fields wherein the server has matched the first URL with a user on file. Once the user device has opened the appropriate application, in action 725 the user can populate the data fields associated with the transaction.

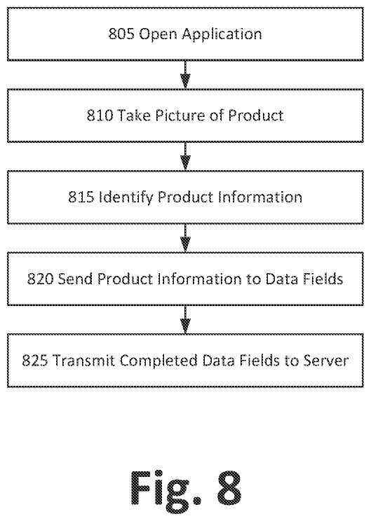

FIG. 8 is a flowchart illustrating a method according to an exemplary embodiment. The method can include a contactless card, a user device, and a server. The method can also include a mobile application or web application. The contactless card is discussed with further reference to FIGS. 2-3. The user device can include one or more cameras configured to recognize product information such as product name, SKU, item code, and barcode information. An item code can itself include a barcode, a quick response (QR) code, a universal product code, or a SKU. In some embodiments, the method includes populating data fields with information captured in a picture of the item purchased.

In action 805, the user device can open a financial planning application. The application can be associated with the user's banking institution or with a third-party financial planning application. This action can be performed by a processor associated with a user device. The user can open the application via a URL sent from a server associated with the application. The URL direction is discussed with further reference to FIG. 7. The application can present a number of data fields to the user via the user device's display. Certain data fields can relate to information associated with the product, such as a stock keeping unit (SKU) or merchant category code (MCC). To capture this information, in action 810 the user device can take a picture of the product. The user device can be configured to have a camera capable of taking a picture of the product and recognize via an application certain product information from the picture. This action can be performed by a camera on the user device. Then, in action 815 the application can identify one or more relevant data from the picture, such as product category, product title, SKU, MCC, price and weight of the product, date of manufacturing and expiration, name of the manufacturer, or some other information. Some of this data can be taken from a barcode on the product or product packaging. Upon identifying or capturing this information, the user device can populate one or more data fields with this information. Some data fields will be specifically tailored to fit the information. But some information may not fit exactly within a specific data field. For such information, there can be catchall or miscellaneous data field for any other information the user wishes to record. In some embodiments, the user device or some user device application can access a spending habit report, wherein the spending habit report has been generated by the user device based on current and historical data fields from current and past transactions. The spending habit report can be retrieved from a database, data storage unit, memory, or from the server. Once the user is finished, they may transmit the completed data fields to the server in action 825.

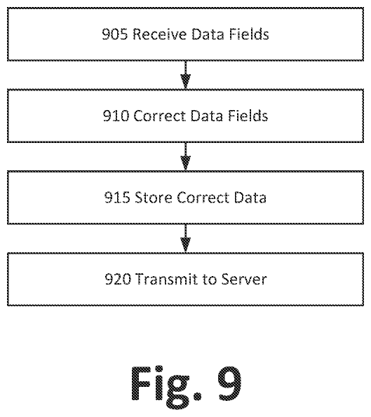

FIG. 9 is a flowchart illustrating a method according to an exemplary embodiment. The method can include a contactless card, a user device, and a server. The method can also include a mobile application or web application. The contactless card is discussed with further reference to FIGS. 2-3. In some embodiments, the server can automatically populate certain data fields. When certain data fields need to be change or edited, the user device can edit the fields.

In action 905, the use device receives the one or more data fields from the server. The data fields can ask for transaction data including without limitation the spend amount per transaction, the spend amount per item, time of transaction, location of transaction, type or category of transaction, frequency of transaction, or some other transaction information. In action 910, the user can edit the data fields via the user device. For example, a user may have recently purchased a pair of shoes. The server may have categorized the purchase as a “clothing” purchase. The user may want to edit the “clothing” field to be more narrowly described. For example, the user may delete “clothing” and instead write “shoes.” It is understood that in other embodiments the user can make different edits based on the context of the purchase. As a nonlimiting example, a user may purchase a trip from a rideshare company. The server may categorize this purchase as “travel.” The user can change “travel” into “transit” since transmit is more specific. Once the user has made the edit, in action 915 the user may store the corrected data fields locally on the user device or on a separate database or data storage unit. Finally, the user device can transmit the completed data fields to the server associated with the financial application in action 920.

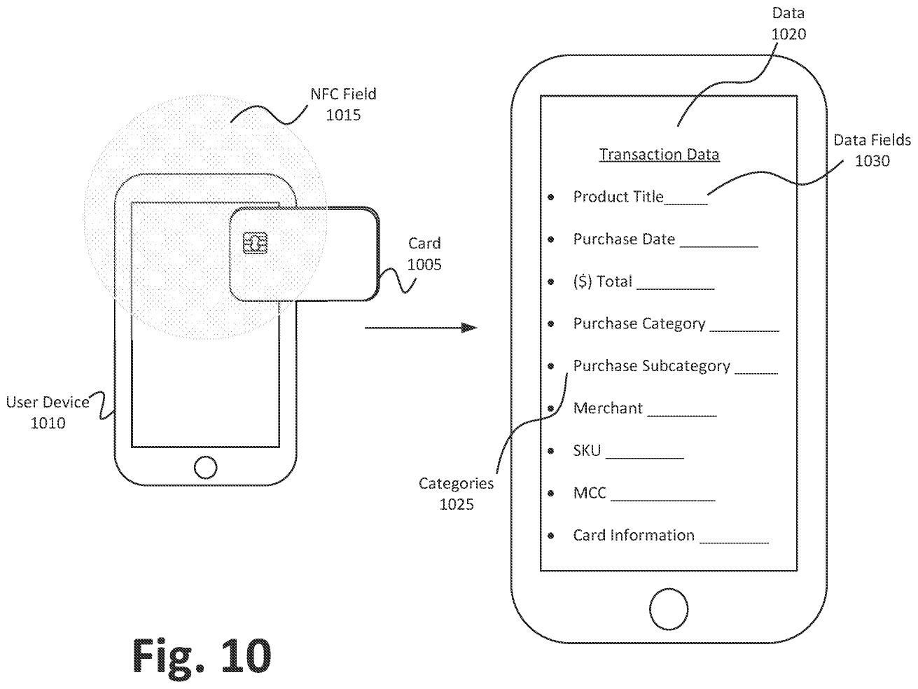

FIG. 10 is a diagram illustrating a process according to an exemplary embodiment. The method can include a contactless card, a user device, and a server. The method can also include a mobile application or web application. The contactless card is discussed with further reference to FIGS. 2-3. In some embodiments, the process can include a contactless card, a user device, and a server.

To retrieve a user's transaction data, the user can perform an authentication with a user device and the contactless card. The presence of both the contactless card and the user device ensures the person attempting to view and edit the transaction data is, in fact, the actual owner of the contactless card. The user can validate himself by tapping a contactless card 1005 to the user device 1010 via an NFC field 1015. The contactless card is discussed with further reference to FIGS. 2-3. The NFC field is discussed with further reference to FIG. 5. The authenticate can include a diversified key exchange in which a MAC is sent from the contactless card to the user device. This authentication method is discussed with further reference to FIG. 4.

Having validated himself, the user can retrieve the transaction data. The transaction data can be retrieved by the user device from server associated with a spending or financial planning application. The transaction data 1020 can be viewed on a display associated with the user device. The transaction data 1020 can include one or more categories 1025 and accompanying data fields 1030. The categories can include, without limitation, purchase title, purchase date, amount spent, purchase category, purchase subcategory, merchant, SKU, MCC, card information, product name, SKU, item code, and barcode information. An item code can itself include a barcode, a quick response (QR) code, a universal product code, or a SKU.

In some embodiments, the data fields can be filled automatically by the mobile application associated with the transaction data. For example, the application may have already filled the purchase date data field. The user can interact with the data fields via the interactive display on the user device. For example, the user can tap or click one of the data fields and type in the desired information. In other embodiments, the application can prompt the user via the display to tap the contactless card again to fill the card information data field. As another nonlimiting example, the application can prompt the user to take a picture of the purchased item or barcode to fill in relevant data fields. The user can request the application to create a new data field not otherwise listed in the application. For example, the user may want to create a data field called “gift” with the which the user can specify whether a certain purchase was a gift. The user can also some data fields that have been auto-populated by the mobile application. For example, the user may change the category data field from “retail” to “clothes.” Once the user has finished interacting with the data fields, the user may save and transmit the completed data fields to the server associated with the financial planning app. If the user wishes to review or re-edit the same data fields, then can reopen the app at which point they may be prompted to authenticate themselves again with their contactless card. In some embodiments, the user device or some user device application can access a spending habit report, wherein the spending habit report has been generated by the user device based on current and historical data fields from current and past transactions. The spending habit report can be retrieved from a database, data storage unit, memory, or from the server.

In some aspects, the techniques described herein relate to a method, including: transmitting, from a user device to a server, a request for transaction data; receiving, by the user device from the server, an authentication request; opening, by the user device in response to receiving an authentication request, a communication field; transmitting, from the user device to a contactless card via the communication field, an authentication request; receiving, by the user device from the contactless card, an authentication credential; transmitting, by the user device to the server, a request for data associated with a completed transaction; receiving, from the server, one or more data associated with the completed transaction; opening, in response to receiving the data associated with the completed transaction, an application configured to display one or more data fields associated with the completed transaction wherein some of the data fields have been populated with the data received from the server; transmitting, by the user device to the application, one or more additional entries to the data fields; storing, by the user device to a data storage unit, the completed data fields; and transmitting, by the user device to the server, the completed data fields.

In some aspects, the techniques described herein relate to a method, further including: receiving, by the user device from the contactless card, a first uniform resource locator (URL); transmitting, by the user device, the URL to the server; receiving, by the user device from the server, a second URL associated with a website application or mobile application further configured to display the one or more data fields wherein the server has matched the first URL with a user on file; and opening the application associated with the second URL.

In some aspects, the techniques described herein relate to a method, wherein the communication field is a near field communication (NFC) field, Bluetooth, or a radio frequency identification (RFID) enabled field.

In some aspects, the techniques described herein relate to a method, wherein the transaction is a consumer transaction between the user and a merchant.

In some aspects, the techniques described herein relate to a method, wherein the authentication credential is a customer identification number associated with the contactless card.

In some aspects, the techniques described herein relate to a method, wherein the user device is further configured to perform a public-private key exchange with the contactless card.

In some aspects, the techniques described herein relate to a method, wherein the user device is further configured to edit the one or more data received from the server before storing the completed data fields in the data storage unit.

In some aspects, the techniques described herein relate to a method, wherein the user device is further configured to receive an item code associated with the transaction and populate a data field with the item code.

In some aspects, the techniques described herein relate to a method, wherein the item code is a barcode, a quick response (QR) code, a universal product code, or a stock keeping unit.

In some aspects, the techniques described herein relate to a method, wherein the steps further include accessing a spending habit report, wherein the spending habit report has been generated by the user device based on current and historical data fields from current and past transactions.

In some aspects, the techniques described herein relate to a system for securely recording transaction details, the system including: a contactless card; a server; and a user device including a memory and a processor, the processor configured to: transmit, from the user device to the server, a request for transaction data; receive, by the user device from the server, an authentication request; open, in response to receiving the authentication request, a communication field; transmit, to the contactless card via the communication field, an authentication request; receive, from the contactless card, an authentication credential; transmit, to the server, a request for data associated with a completed transaction; receive, from the server in response to the request for data, one or more data associated with the completed transaction; open, in response to receiving the data associated with the completed transaction, an application configured to display via the user device one or more data fields associated with the completed transaction wherein some of the data fields have been populated with the data received from the server; transmit, to the application, one or more additional entries to the data fields; store the completed data fields in a data storage unit; and transmit, to the server, the completed data fields.

In some aspects, the techniques described herein relate to a system, wherein the data fields include time dates, merchant names, and item names.

In some aspects, the techniques described herein relate to a system, wherein the data fields include a merchant categorization code (MCC) and location of the transaction.

In some aspects, the techniques described herein relate to a system, wherein processor is further configured to access a spending habit report, wherein the spending habit report has been generated by current and historical data fields from current and past transactions.

In some aspects, the techniques described herein relate to a system, wherein the processor further configured to populate at least one data field with card information upon the contactless card entering the communication field.

In some aspects, the techniques described herein relate to a system, wherein the user device further includes a camera configured to scan an item code associated with the transaction.

In some aspects, the techniques described herein relate to a system, wherein the data storage unit is configured to store current and historical transaction data associated with purchases made by the user in connection with the contactless card.

In some aspects, the techniques described herein relate to a system, wherein the processor is further configured to edit, upon receiving information given by the user, data fields that have already been populated by the server.

In some aspects, the techniques described herein relate to a computer readable non-transitory medium including computer executable instructions that, when executed on a processor, configure the processor to perform procedures including: transmitting, from a user device to a server, a request for transaction data; receiving, by the user device from the server, an authentication request; opening, in response to receiving the authentication request, a communication field; transmitting, to a contactless card via the communication field, an authentication request; receiving, from the contactless card, an authentication credential; transmitting, to the server, a request for one or more data associated with a completed transaction; receiving, from the server in response to the request for data, one or more data associated with the completed transaction; opening, in response to receiving the data associated with the completed transaction, an application configured to display via the user device one or more data fields associated with the completed transaction wherein some of the data fields have been populated with the data received from the server; transmitting, to the application, one or more additional entries to the data fields; storing, in a data storage unit, the completed data fields; and transmitting, to the server, the completed data fields.

In some aspects, the techniques described herein relate to a computer-readable non-transitory medium, wherein the procedures further include: receiving, by the user device from the contactless card, a first uniform resource locator (URL); transmitting, by the user device, the URL to the server; receiving, by the user device from the server, a second URL associated with a website application or mobile application further configured to display the one or more data fields wherein the server has matched the first URL with a user on file; and open the application associated with the second URL. 067519.0003691 DMS 90560181v3 067519.0003691 DMS 90560181v3

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

As used herein, the terms “card” and “contactless card” are not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, or membership cards), to cards associated with a particular type of account (e.g., a credit account, a debit account, a membership account), or to cards issued by a particular entity (e.g., a financial institution, a government entity, or a social club). Instead, it is understood that the present disclosure includes cards having any purpose, account association, or issuing entity.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

What is claimed is:

1. A method, comprising:
transmitting, from a user device to a server, a request for transaction data;
receiving, by the user device from the server, an authentication request;
opening, by the user device in response to receiving an authentication request, a communication field;
transmitting, from the user device to a contactless card via the communication field, an authentication request;
receiving, by the user device from the contactless card, an authentication credential;
transmitting, by the user device to the server, a request for data associated with a completed transaction;
receiving, from the server, one or more data associated with the completed transaction;
opening, in response to receiving the data associated with the completed transaction, an application configured to display one or more data fields associated with the completed transaction wherein some of the data fields have been populated with the data received from the server;
transmitting, by the user device to the application, one or more additional entries to the data fields;
storing, by the user device to a data storage unit, the completed data fields; and
transmitting, by the user device to the server, the completed data fields.

2. The method of claim 1, further comprising:
receiving, by the user device from the contactless card, a first uniform resource locator (URL);
transmitting, by the user device, the URL to the server;
receiving, by the user device from the server, a second URL associated with a website application or mobile application further configured to display the one or more data fields wherein the server has matched the first URL with a user on file; and
opening the application associated with the second URL.

3. The method of claim 1, wherein the communication field is a near field communication (NFC) field, Bluetooth, or a radio frequency identification (RFID) enabled field.

4. The method of claim 1, wherein the transaction is a consumer transaction between the user and a merchant.

5. The method of claim 1, wherein the authentication credential is a customer identification number associated with the contactless card.

6. The method of claim 1, wherein the user device is further configured to perform a public-private key exchange with the contactless card.

7. The method of claim 1, wherein the user device is further configured to edit the one or more data received from the server before storing the completed data fields in the data storage unit.

8. The method of claim 1, wherein the user device is further configured to receive an item code associated with the transaction and populate a data field with the item code.

9. The method of claim 8, wherein the item code is a barcode, a quick response (QR) code, a universal product code, or a stock keeping unit.

10. The method of claim 1, wherein the steps further comprise accessing a spending habit report, wherein the spending habit report has been generated by the user device based on current and historical data fields from current and past transactions.

11. A system for securely recording transaction details, the system comprising:
a contactless card;
a server; and
a user device comprising a memory and a processor, the processor configured to:
transmit, from the user device to the server, a request for transaction data;
receive, by the user device from the server, an authentication request;
open, in response to receiving the authentication request, a communication field;
transmit, to the contactless card via the communication field, an authentication request;
receive, from the contactless card, an authentication credential;
transmit, to the server, a request for data associated with a completed transaction;
receive, from the server in response to the request for data, one or more data associated with the completed transaction;
open, in response to receiving the data associated with the completed transaction, an application configured to display via the user device one or more data fields associated with the completed transaction wherein some of the data fields have been populated with the data received from the server;
transmit, to the application, one or more additional entries to the data fields;
store the completed data fields in a data storage unit; and
transmit, to the server, the completed data fields.

12. The system of claim 11, wherein the data fields comprise time dates, merchant names, and item names.

13. The system of claim 11, wherein the data fields comprise a merchant categorization code (MCC) and location of the transaction.

14. The system of claim 11, wherein processor is further configured to access a spending habit report, wherein the spending habit report has been generated by current and historical data fields from current and past transactions.

15. The system of claim 11, wherein the processor further configured to populate at least one data field with card information upon the contactless card entering the communication field.

16. The system of claim 11, wherein the user device further comprises a camera configured to scan an item code associated with the transaction.

17. The system of claim 11, wherein the data storage unit is configured to store current and historical transaction data associated with purchases made by the user in connection with the contactless card.

18. The system of claim 11, wherein the processor is further configured to edit, upon receiving information given by the user, data fields that have already been populated by the server.

19. A computer readable non-transitory medium comprising computer executable instructions that, when executed on a processor, configure the processor to perform procedures comprising:
transmitting, from a user device to a server, a request for transaction data;
receiving, by the user device from the server, an authentication request;
opening, in response to receiving the authentication request, a communication field;
transmitting, to a contactless card via the communication field, an authentication request;
receiving, from the contactless card, an authentication credential;
transmitting, to the server, a request for one or more data associated with a completed transaction;
receiving, from the server in response to the request for data, one or more data associated with the completed transaction;
opening, in response to receiving the data associated with the completed transaction, an application configured to display via the user device one or more data fields associated with the completed transaction wherein some of the data fields have been populated with the data received from the server;
transmitting, to the application, one or more additional entries to the data fields;
storing, in a data storage unit, the completed data fields; and
transmitting, to the server, the completed data fields.

20. The computer-readable non-transitory medium of claim 19, wherein the procedures further comprise:
receiving, by the user device from the contactless card, a first uniform resource locator (URL);
transmitting, by the user device, the URL to the server;
receiving, by the user device from the server, a second URL associated with a website application or mobile application further configured to display the one or more data fields wherein the server has matched the first URL with a user on file; and
open the application associated with the second URL.
